(19) United States
(12) Patent Application Publication
(10) Pub. No.: US 2015/0094407 A1
(43) Pub. Date: Apr. 2, 2015

(54) PERFLUOROELASTOMER COMPOSITION

(71) Applicant: UNIMATEC CO., LTD, Tokyo (JP)

(72) Inventors: Daisuke Murai, Ibaraki (JP); Mitsuru Maeda, Ibaraki (JP)

(73) Assignee: UNMATEC CO., LTD., Tokyo (JP)

(21) Appl. No.: 14/387,503

(22) PCT Filed: Feb. 28, 2013
(86) PCT No.: PCT/JP2013/055376

§ 371 Date: Sep. 23, 2014

(30) Foreign Application Priority Data
Apr. 9, 2012 (JP) 2012-088100

(51) Int. Cl. C08L 27/18; C08K 5/3437

(52) U.S. Cl. CPC C08L 27/18; C08K 5/3437
USPC 524/90; 524/546

(57) ABSTRACT

Disclosed is a perfluoroelastomer composition comprising 100 parts by weight of a perfluoroelastomer containing a cyano group as a crosslinkable group, 0.2 to 5 parts by weight of a bisamidoxime compound vulcanizing agent represented by the general formula: HON═C(NH₂)—(CF₂)ₙ—C(NH₂)═NOH (n: an integer of 1 to 10), and 0.005 to 0.3 parts by weight of a coloring agent with a melting point of 300° C. or above. This perfluoroelastomer composition provides a colored molded product that does not form blooms under high temperature conditions of 300° C. or above, and that can be effectively used, for example, as a sealing material for semiconductor manufacturing devices.

### TECHNICAL FIELD

The present invention relates to a perfluoroelastomer composition. More particularly, the present invention relates to a perfluoroelastomer composition that provides a colored perfluoroelastomer molded product having heat resistance under high temperature conditions of 300° C. or above.

### BACKGROUND ART

Fluorine-containing elastomers, such as fluorinated fluoroelastomers (e.g., a vinylidene fluoride [VdF]/hexafluoropropylene [HFP] copolymer and a VdF/HFP/tetrafluoroethylene [TFE] terpolymer) and perfluorinated perfluoroelastomers (e.g., a TFE/perfluoromethylvinylether [PMVE] copolymer) have excellent performance in terms of heat resistance, chemical resistance, etc., as compared to other rubbers. They are therefore widely used as molding materials for sealing materials, such as O rings, gaskets, and packing, in various industrial fields, including automobile industry.

In particular, perfluoroelastomers, which are polymers comprising perfluoromonomers, such as TFE, HFP, and PMVE, have superior heat resistance and chemical resistance, as compared to other fluorine-containing elastomers than perfluoroelastomers; however, for semiconductor applications and some other applications, perfluoroelastomers are required to be used in an environment at 300° C., but their heat resistance is not sufficient for that environment. Furthermore, there may be limitations on the use of reinforcing materials and fillers, in terms of metal or contamination.

Patent Document 1 discloses a fluororubber composition comprising:
(a) a peroxide-crosslinkable tetrafluoroethylene-perfluoro(alkyl vinyl ether) copolymer elastomer or vinylidene fluoride-hexafluoropropene copolymer elastomer obtained by a copolymerization reaction of a fluorine-containing olefin in the presence of a bromine- and/or iodine-containing crosslinking-site forming compound;
(b) an organic peroxide crosslinking agent;
(c) a polyfunctional unsaturated compound co-crosslinking agent; and
(d) a triallyl isocyanurate polymer;
   the fluororubber composition being free of carbon black and a metal-containing filler. This fluororubber composition is supposed to provide a vulcanizate that has excellent vulcanizate physical properties. However, referring to the compression set resistance characteristics of the vulcanizates shown in the Examples of Patent Document 1 at 200° C. and the results of an air aging test at 250° C., it is hard to say that the vulcanizates have sufficient heat resistance at 300° C., which is required for semiconductor applications, etc.

Patent Document 2 discloses a composition comprising:
a perfluoroelastomer containing a cyano group as a crosslinkable group; and
a bisamidoxime compound, as a vulcanizing agent, represented by the following general formula:

HON═C(NH₂)—(CF₂)ₙ—C(NH₂)═NOH
n: 1 to 10.
   However, it is difficult to use the compositions shown in the Examples of Patent Document 2 for some applications, such as applications for which high cleanness is required, because they contain carbon black as a reinforcing material. Moreover, from the compression set values of the compositions at 300° C. shown in the Examples, it is hard to consider that the compositions have sufficient heat resistance to withstand use at high temperatures.

Patent Document 3 discloses a composition comprising, as a perfluoroelastomer containing a cyano group, a fluorine-containing elastomer having a copolymerization composition comprising:
(A) 72.8 to 74.0 mol % of tetrafluoroethylene;
(B) 26.8 to 24.0 mol % of perfluoro(lower alkyl vinyl ether) or perfluoro(lower alkoxy lower alkyl vinyl ether); and
(C) 0.2 to 3.0 mol % of a perfluoro unsaturated nitrile compound;
   the composition also comprising the abovementioned bisamidoxime compound. This composition has the effect of providing a perfluoroelastomer vulcanizate that has not only excellent heat resistance, but also excellent plasma resistance, which is particularly important for semiconductor applications; however, the color of the resulting product is yellow to transparent light yellow, which tends to result in hue unevenness, thereby impairing the appearance of the product. Moreover, the composition has excellent normal-state physical properties at 300° C.; however, when the composition is continuously used at 300° C. for a long period of time, hue changes are more likely to occur.

Meanwhile, Patent Document 4 discloses a fluorine-containing elastomer composition comprising:
100 parts by weight of a fluorine-containing elastomer; and
0.5 to 20 parts by weight of at least one member selected from the group consisting of an isoindolinone pigment, a quinacridone pigment, a diketopyrrolopyrrole pigment, and an anthraquinone pigment;
   the fluorine-containing elastomer composition being capable of improving the plasma resistance of a vulcanized product of the composition. However, it is hard to say that the composition has sufficient heat resistance at around 250° C., as well as 300° C. or above.

### PRIOR ART DOCUMENT

### Patent Document

Patent Document 1: JP-A-2005-344074

Patent Document 2: JP-B-3082626

Patent Document 3: JP-A-2009-161662

Patent Document 4: JP-B-4720501

### OUTLINE OF THE INVENTION

### Problem to be Solved by the Invention

An object of the present invention is to provide a perfluoroelastomer composition providing a colored vulcanizate (a colored molded product) that does not form blooms under high temperature conditions of 300° C. or above, and that can be effectively used, for example, as a sealing material for semiconductor manufacturing devices.

### Means for Solving the Problem

The above object of the present invention can be achieved by a perfluoroelastomer composition comprising:

100 parts by weight of a perfluoroelastomer containing a cyano group as a crosslinkable group;

0.2 to 5 parts by weight of a bisamidoxime compound vulcanizing agent represented by the general formula:

HON═C(NH₂)—(CF₂)ₙ—C(NH₂)═NOH

wherein n is an integer of 1 to 10; and

0.005 to 0.3 parts by weight of a coloring agent with a melting point of 300° C. or above.

### Effect of the Invention

A perfluoroelastomer colored molded product obtained by vulcanization molding of the perfluoroelastomer composition of the present invention does not undergo discoloration or form blooms under high temperature conditions of 300° C. or above, and has excellent heat resistance. Therefore, the perfluoroelastomer colored molded product can be effectively used, for example, as a sealing material for semiconductor manufacturing devices, for plasma irradiation.

### EMBODIMENTS FOR CARRYING OUT THE INVENTION

The composition of the perfluoroelastomer containing a cyano group as a crosslinkable group is not limited, as long as it can provide a vulcanizate having excellent heat resistance at a high temperature of 300° C. or above; however, the perfluoroelastomer preferably has a copolymerization composition comprising:
(A) 68 to 74 mol % of tetrafluoroethylene;
(B) 30 to 24 mol % of perfluoro(lower alkyl vinyl ether) or perfluoro(lower alkoxy lower alkyl vinyl ether); and
(C) 0.2 to 3.0 mol % of a perfluoro unsaturated nitrile compound; and the perfluoroelastomer preferably has a Mooney viscosity ML₁₊₁₀(121° C.) of 70 to 115.

When the copolymerization ratio of tetrafluoroethylene as the component (A) is lower than this range, heat resistance is inferior, and adhesion to silicon, metal, silica glass, etc., increases. In contrast, when the copolymerization ratio of tetrafluoroethylene as the component (A) is greater than this range, the resulting copolymer behaves likes a resin, rather than an elastomer, thus degrading sealing performance and reducing processability.

When the copolymerization ratio of perfluoro(lower alkyl vinyl ether) or perfluoro(lower alkoxy lower alkyl vinyl ether) as the component (B) is lower than this range, the copolymerization ratio of tetrafluoroethylene is relatively higher, and the resulting copolymer becomes a resin-like state, significantly degrading sealing performance. On the other hand, when the copolymerization ratio of the component (B) is greater than this range, particularly adhesion is remarkably deteriorated.

Examples of the perfluoro(lower alkyl vinyl ether) as the component (B) comonomer typically include perfluoro(methyl vinyl ether), perfluoro(ethyl vinyl ether), perfluoro(propyl vinyl ether), and the like. Moreover, examples of the perfluoro(lower alkoxy lower alkyl vinyl ether) are as follows:

| | |
|---|---|
| CF₂═CFOCF₂CF(CF₃)OCₙF₂ₙ₊₁ | (n: 1 to 5) |
| CF₂═CFO(CF₂)₃OCₙF₂ₙ₊₁ | (n: 1 to 5) |
| CF₂═CFOCF₂CF(CF₃)O(CF₂O)ₘCₙF₂ₙ₊₁ | (n: 1 to 5, m: 1 to 3) |
| CF₂═CFO(CF₂)₂OCₙF₂ₙ₊₁ | (n: 1 to 5) |

Among these examples, those wherein CₙF₂ₙ₊₁is CF₃ are particularly preferably used.

Furthermore, examples of the perfluoro unsaturated nitrile compound as the component (C) comonomer, which is used as a crosslinking-site monomer, are as follows:

| | |
|---|---|
| CF₂═CFO(CF₂)ₙOCF(CF₃)CN | (n: 2 to 5) |
| CF₂═CF[OCF₂CF(CF₃)]ₙO(CF₂)ₘCN | (n: 1 or 2, m: 1 to 6) |
| CF₂═CFO(CF₂)ₙCN | (n: 1 to 8) |
| CF₂═CF[OCF₂CF(CF₃)]ₙOCF₂CF(CF₃)CN | (n: 1 or 2) |
| CF₂═CFO(CF₂)ₙ(p-C₆H₄)CN | (n: 1 to 6) |

The amount of copolymerization of the perfluoro unsaturated nitrile compound as the component (C) is 0.2 to 3.0 mol %, preferably 0.5 to 2.0 mol %, which is required as a crosslinkable group.

The copolymerization reaction using these monomers is generally carried out in the following manner: Water, a fluorine-containing emulsifier (e.g., ammonium perfluorooctanoate), and a buffer (e.g., potassium dihydrogen phosphate) are charged in a stainless steel autoclave. Thereafter, tetrafluoroethylene, perfluoro(lower alkyl vinyl ether) or perfluoro(lower alkoxy lower alkyl vinyl ether), and a perfluoro unsaturated nitrile compound are charged, and the temperature is raised to about 50 to 80° C. Then, a redox initiator composed of a radical generator (e.g., ammonium persulfate) and a reducing agent (e.g., sodium sulfite) is added. The reaction pressure is preferably maintained at about 0.75 to 0.85 MPa. Accordingly, in order to increase the pressure in the reactor that decreases with the progress of the reaction, it is preferable to perform the reaction while adding a mixture of these three monomers in batches.

The perfluoroelastomer terpolymer comprising the above components as essential components can be copolymerized with other fluorinated olefins, various vinyl compounds, etc., in an amount that does not inhibit the copolymerization reaction and that does not impair vulcanizate physical properties (about 20 mol % or less). Examples of other fluorinated olefins include vinylidene fluoride, monofluoroethylene, trifluoroethylene, trifluoropropylene, pentafluoropropylene, hexafluoropropylene, hexafluoroisobutylene, chlorotrifluoroethylene, and dichlorodifluoroethylene. Examples of vinyl compounds include ethylene, propylene, 1-butene, isobutylene, methyl vinyl ether, ethyl vinyl ether, butyl vinyl ether, cyclohexyl vinyl ether, vinyl acetate, vinyl propionate, vinyl chloride, vinylidene chloride, and trifluorostyrene.

The perfluoroelastomer containing a cyano group is mixed with, as a vulcanizing agent, a bisamidoxime compound represented by the general formula:

HON═C(NH₂)—(CF₂)ₙ—C(NH₂)═NOH

n: 1 to 10,

as described in Patent Document 2, mentioned above, in an amount of 0.2 to 5 parts by weight, preferably 0.5 to 2 parts by weight, based on 100 parts by weight of the perfluoroelastomer.

The perfluoroelastomer containing a cyano group is further mixed with a coloring agent in an amount of 0.005 to 0.3 parts by weight, preferably 0.01 to 0.2 parts by weight, based on 100 parts by weight of the perfluoroelastomer. When the amount of coloring agent used is less than this range, the coloring effect may be insufficient, depending on the type of coloring agent. In contrast, when the amount of coloring agent used is greater than this range, the coloring agent, depending on its type, may be slightly sublimated, thereby leading to vaporization of a very small amount of coloring agent even at a temperature below the melting point. Consequently, the vulcanized molded product used at 300° C. may undergo slight color fading, and undesirable contamination may occur in the oven during oven vulcanization for the production of the vulcanized molded product. Patent Document 4 discloses a fluorine-containing elastomer composition comprising, as a compound having plasma antiaging effects, at least one member selected from the group consisting of an isoindolinone pigment, a quinacridone pigment, a diketopyrrolopyrrole pigment, and an anthraquinone pigment. However, such a pigment is used in an amount of 0.5 to 20 parts by weight, based on 100 parts by weight of the fluorine-containing elastomer. Thus, the amount of pigment used in Patent Document 4 is higher than the upper limit of the amount of coloring agent specified in the present invention.

Since the coloring agent is intended to be used in an environment in which heat resistance at 300° C. or above is required (e.g., for semiconductor applications), a metal element-free organic compound that does not decompose at 300° C. is used. An organic compound having a melting point of 300° C. or above is preferably used, in terms of preventing bleed out from the vulcanized molded product or preventing vaporization. Examples of such organic compounds include quinacridone (melting point: 390° C.), coronene (melting point: 428° C.), perylenetetracarboxylic acid diimide (melting point: 310 to 320° C.), and 4,4′-diamino-1,1′-bianthracene-9,9′,10,10′-tetraone (melting point: 356° C.). In particular, coronene is preferably used.

The preparation of the perfluoroelastomer composition comprising the above essential components is performed by kneading with two-rolls, or the like, at about 30 to 60° C. The crosslinking of the composition is performed by heating at about 100 to 250° C. for about 1 to 120 minutes. When the composition is subjected to secondary vulcanization, it is performed in an inert gas atmosphere, such as nitrogen gas, at about 150 to 280° C. In that case, it is preferable to perform oven vulcanization along with a gradual temperature increase, as described in Examples below.

### EXAMPLES

The following describes the present invention with reference to Examples.

### Example 1

A bisamidoxime compound [HON═C(NH₂)—(CF₂)₄—C(NH₂)═NOH] (0.7 parts by weight) and 0.1 parts by weight of quinacridone (melting point: 390° C.) were added to 100 parts by weight of a copolymer having a copolymerization composition comprising TFE, PMVE, and perfluoro(3-oxa-8-cyano-1-octene) [CPeVE; CF₂═CFO(CF₂)₄CN] (74.0/24.7/1.3 mol %) [perfluoroelastomer A]. The mixture was kneaded on a two-roll mill at a temperature of 40 to 45° C. The kneaded product was subjected to press vulcanization (primary vulcanization) at 180° C. for 30 minutes, and then to oven vulcanization (secondary vulcanization) in a nitrogen gas atmosphere under the following conditions:
Left at 90° C. for 4 hours.
Temperature was raised from 90° C. to 204° C. over 6 hours.
Left at 204° C. for 18 hours.
Temperature was raised from 204° C. to 288° C. over 6 hours.
Left at 288° C. for 18 hours.

### Example 2

In Example 1, the same amount of coronene (melting point: 428° C.) was used in place of quinacridone.

### Example 3

In Example 1, the same amount of a copolymer having a composition comprising TFE, PMVE, and CPeVE (69.0/29.7/1.3 mol %) [perfluoroelastomer B] was used in place of the perfluoroelastomer A.

### Example 4

In Example 2, the amount of coronene was changed to 0.02 parts by weight.

### Example 5

In Example 2, the amount of coronene was changed to 0.2 parts by weight.

### Comparative Example 1

In Example 1, quinacridone was not used.

### Comparative Example 2

In Example 1, the same amount of N,N′-dimethylquinacridone (melting point: 286° C.) was used in place of quinacridone.

### Comparative Example 3

In Example 1, the same amount of perylene (melting point: 276° C.) was used in place of quinacridone.

### Comparative Example 4

In Example 1, the amount of quinacridone was changed to 0.4 parts by weight. Undesirable contamination was observed in the oven during oven vulcanization.

The vulcanized molded products obtained in the Examples and Comparative Examples above were subjected to the measurement of normal-state physical properties, the measurement of compression set, the evaluation of color transfer, the observation of product color (change), a plasma irradiation test, and an outgas test.
Normal-state physical properties: DIN53505 (hardness)
DIN53503 (tensile test)
Compression set: ASTM Method B; The compression set of a P-24 O ring was measured at 275° C., 300° C., or 315° C., for 70 hours.
Color transfer: Coloring of the mold after the measurement of compression set (at 300° C. for 70 hours) was visually evaluated.
Product color (change): The product color before and after the measurement of compression set (at 300° C. for 70 hours) was visually observed.
Plasma irradiation test (rate of weight loss): RBH3030 (produced by ULVAC, Inc.) was used.
   O₂ plasma
   RF output: 1,500 W
   Irradiation time: 6 hours
   Degree of vacuum: 0.1 Torr
Outgas test: TDS (produced by GERSTEL K. K.) was used.
   TDS (thermal desorption system): 150° C., 200° C., or 250° C., for 3 minutes
   CIS (cooled injection system): 300° C. for 2 minutes
   GC/MS (AGILENT6890/5973-GC/MS)
   Column: ZB-1 (30 m×0.32 mm×0.5 μm)
   The total amount of outgas was measured while the temperature was raised at 15° C./min from 40° C. to 320° C.

The following table shows the obtained results.

TABLE

| | Example | | | | | Comparative Example | | | |
|---|---|---|---|---|---|---|---|---|---|
| Measurement item | 1 | 2 | 3 | 4 | 5 | 1 | 2 | 3 | 4 |
| Hardness (Shore A) | 81 | 80 | 68 | 80 | 80 | 80 | 81 | 81 | 81 |
| Tensile test | | | | | | | | | |
| 100% modulus | 6.0 | 6.2 | 4.5 | 6.3 | 6.2 | 6.3 | 6.0 | 5.9 | 6.1 |
| (MPa) | | | | | | | | | |
| Breaking strength | 16.6 | 15.1 | 16.4 | 15.7 | 15.3 | 15.5 | 15.3 | 16.1 | 15.5 |
| (MPa) | | | | | | | | | |
| Elongation at break | 220 | 190 | 260 | 200 | 200 | 200 | 200 | 210 | 210 |
| (%) | | | | | | | | | |
| Compression set | | | | | | | | | |
| 275° C., 70 hrs (%) | 19 | 18 | 27 | 18 | 18 | 18 | 17 | 20 | 19 |
| 300° C., 70 hrs (%) | 20 | 21 | 31 | 20 | 20 | 20 | 20 | 21 | 20 |
| 315° C., 70 hrs (%) | 29 | 32 | 35 | 31 | 29 | 30 | 28 | 30 | 30 |
| Color transfer | None | None | None | None | None | None | Transferred | Transferred | None |
| Product color | | | | | | | | | |
| Initial | Red | Black | Red | Black | Black | Light | Red | Red | Black |
| | purple | | purple | | | yellow | | brown | |
| | | | | | | (uneven) | | | |
| After 70 hrs at | Red | Black | Red | Black | Black | Almost | Black | Red | Red |
| 300° C. | purple | | purple | | | colorless | | purple | purple |
| | | | | | | (uneven) | | | |
| Product color change | None | None | None | None | None | Changed | Changed | Changed | Changed |
| Plasma test | | | | | | | | | |
| Weight loss rate (%) | 42 | 42 | 45 | 40 | 42 | 40 | 41 | 42 | 42 |
| Outgas test | | | | | | | | | |
| 150° C. (ppm) | 0 | 0 | 0 | 0 | 0 | 0 | 0 | 1 | 0 |
| 200° C. (ppm) | 1 | 1 | 1 | 0 | 1 | 1 | 1 | 2 | 2 |
| 250° C. (ppm) | 1 | 2 | 1 | 1 | 1 | 1 | 5 | 6 | 3 |

1. A perfluoroelastomer composition comprising:
100 parts by weight of a perfluoroelastomer containing a cyano group as a crosslinkable group;
0.2 to 5 parts by weight of a bisamidoxime compound vulcanizing agent represented by the general formula:
HON═C(CH₂)—(CF₂)ₙ—C(NH₂)═NOH
wherein n is an integer of 1 to 10; and
0.005 to 0.3 parts by weight of a coloring agent with a melting point of 300° C. or above.

2. The perfluoroelastomer composition according to claim 1, wherein the perfluoroelastomer has a copolymerization composition comprising:
(A) 68 to 74 mol % of tetrafluoroethylene;
(B) 30 to 24 mol % of perfluoro(lower alkyl vinyl ether) or prefluoro(lower alkoxy lower alkyl vinyl ether); and
(C) 0.2 to 3.0 mol % of a perfluoro unsaturated nitrile compound; and
wherein the perfluoroelastomer has a Mooney viscosity ML₁₊₁₀ (212° C.) of 70 to 115.

3. The perfluoroelastomer composition according to claim 1, wherein the coloring agent with a melting point of 300° C. or above is a metal element-free organic compound that does not decompose at 300° C.

4. The perfluoroelastomer composition according to claim 3, wherein the metal element-free organic compound coloring agent is quinacridone, coronene, perylenetetracarboxylic acid diimide, or 4,4′-diamino-1,1′-bianthracene-9,9′,10,10′-tetraone.

5. The perfluoroelastomer composition according to claim 1, which is free of a filler other than the coloring agent with a melting point of 300° C. or above.

6. A colored molded product obtained by vulcanization molding of the perfluoroelastomer composition according to claim 1.

7. The colored molded product according to claim 6, wherein the colored molded product is a colored sealing material.

8. The colored sealing material according to claim 7, which is used for plasma irradiation.

9. The colored sealing material according to claim 8, which is used for semiconductor manufacturing device.

10. A colored molded product obtained by vulcanization molding of the perfluoroelastomer composition according to claim 2.

11. A colored molded product obtained by vulcanization molding of the perfluoroelastomer composition according to claim 3.

12. A colored molded product obtained by vulcanization molding of the perfluoroelastomer composition according to claim 4.

13. A colored molded product obtained by vulcanization molding of the perfluoroelastomer composition according to 5.

14. The colored molded product according to claim 10, wherein the colored molded product is a colored sealing material.

15. The colored molded product according to claim 11, wherein the colored molded product is a colored sealing material.

16. The colored molded product according to claim 12, wherein the colored molded product is a colored sealing material.

17. The colored molded product according to claim 13, wherein the colored molded product is a colored sealing material.

18. The colored sealing material according to claim 14, which is used for plasma irradiation.

19. The colored sealing material according to claim 15, which is used for plasma irradiation.

20. The colored sealing material according to claim 16, which is used for plasma irradiation.
